(19) United States
(12) Patent Application Publication
(10) Pub. No.: US 2010/0102707 A1
(43) Pub. Date: Apr. 29, 2010

(54) RED FLUORESCENT SUBSTANCE AND LIGHT-EMITTING DEVICE EMPLOYING THE SAME

(75) Inventors: Yumi FUKUDA, Tokyo (JP); Naotoshi MATSUDA, Chigasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/606,279

(22) Filed: Oct. 27, 2009

(30) Foreign Application Priority Data
Oct. 29, 2008 (JP) 2008-278642

(51) Int. Cl. H01J 1/63; C09K 11/64; C09K 11/59

(52) U.S. Cl. 313/503; 252/301.6 R; 252/301.4 R

(57) ABSTRACT

The present invention provides a red fluorescent substance and a light-emitting device utilizing the substance. This device less suffers from color drift even when working with high power. The light-emitting device comprises a blue LED, a green fluorescent substance of Sr₃Al₃Si₁₃O₂N₂₁ activated with a luminescent center, and the red fluorescent substance. The red fluorescent substance contains an inorganic compound comprising a metal element M, a trivalent element M¹ other than the M, a tetravalent element M² other than the M, and nitrogen element. In the inorganic compound, the M is partly replaced with a luminescent center element EC. The red fluorescent substance has basically the same crystal structure as Sr₂Al₃Si₇ON₁₃. The red fluorescent substance emits luminescence having a peak in the range of 580 to 650 nm when excited with light of 250 to 500 nm.

### CROSS-REFERENCE TO RELATED APPLICATIONS

This application is based upon and claims the benefit of priority from the prior Japanese Patent Application No. 2008-278642, filed on Oct. 29, 2008; the entire contents of which are incorporated herein by reference.

### BACKGROUND OF THE INVENTION

1. Field of the Invention

The present invention relates to a light-emitting device utilizing fluorescent substances. In particular, this invention relates to a light-emitting device in which plural fluorescent substances giving emissions at different wavelengths are used in combination.

2. Background Art

LED lamps, which utilize light-emitting diodes, are used in many displaying elements of instruments such as mobile devices, PC peripheral equipments, OA equipments, various kinds of switches, light sources for backlighting, and indicating boards. The LED lamps are strongly required not only to have high efficiency, but also to be excellent in color rendition when used for general lighting or to deliver a wide color gamut when used for backlighting. In order to increase the efficiency, it is necessary to adopt highly efficient fluorescent substances. Further, for improving the color rendition and for broadening the color gamut, fluorescent substances giving green and red emissions when excited with blue light are preferably combined with a blue excitation light source LED to produce a white light lamp.

Incidentally, high load LED lamps generally become so hot while working that fluorescent substances used therein are heated up to a temperature of approx. 100 to 200° C. When the fluorescent substances are thus heated, their emission intensity is generally lowered. Accordingly, it is desired that the emission intensity be less lowered even if the fluorescent substances are heated. In other words, it is desired to reduce thermal quenching of the fluorescent substances.

In view of the above, Eu-activated alkaline earth orthosilicate phosphors can be regarded as examples of the fluorescent substances which emit green or red luminescence under the excitation with blue light and hence which are suitably used for the aforementioned LED lamps. The absorption ratio, internal quantum efficiency and external quantum efficiency of the phosphor giving green luminescence under the excitation at 460 nm are 73%, 85% and 62%, respectively, while those of the phosphor giving red luminescence under the excitation at 460 nm are 82%, 66% and 54%, respectively. The combination of these fluorescent substances gives white light so excellent both in efficiency and in color rendition that the luminous efficacy and the average color rendition index thereof are 186 lm/W and Ra=86, respectively. (JP-A 2004-115633(KOKAI), JP-A 2002-531955(KOKAI), JP-A 2005-520916(KOKAI), and JP-A 2004-516688(KOKAI))

However, if those Eu-activated alkaline earth orthosilicate phosphors are used in a high load LED lamp, the emission intensity is often lowered as described above. When the lamp is heated, those fluorescent substances seriously undergo thermal quenching although the emission intensity of the blue LED is less lowered. Consequently, the light emitted from the fluorescent substances is liable to lose the balance with that from the LED. Further, since the thermal quenching of the green fluorescent substance does not always proceed in the same way as that of the red fluorescent substance, the balance between green and red luminescence is also liable to become impaired according to increase of the load. As a result, blue, green and red emissions are often out of balance, so that serious “color drift” is likely to be caused.

### SUMMARY OF THE INVENTION

A fluorescent substance according to one aspect of the present invention is characterized by comprising an inorganic compound which comprises:

a metal element M,
an element M¹ selected from the group of trivalent elements other than said metal element M,
an element M² selected from the group of tetravalent elements other than said metal element M, and
nitrogen element,

said metal element M being partly replaced with a luminescent center element EC;

wherein chemical bond lengths of M¹-N and M²-N calculated from a lattice constants and atomic coordinates in the crystal structure of said fluorescent substance are within the range of ±15% based on those of Al—N and Si—N, respectively, calculated from the lattice constants and atomic coordinates of Sr₂Al₃Si₇ON₁₃.

Further, a light-emitting device according to another aspect of the present invention comprises

a light-emitting chip (S1) giving off light in the wavelength range of 250 to 500 nm;

a fluorescent substance (R) comprising an inorganic compound which comprises:

a metal element M,
an element M¹ selected from the group of trivalent elements other than said metal element M,
an element M² selected from the group of tetravalent elements other than said metal element M, and
nitrogen element,

said metal element M being partly replaced with a luminescent center element EC;

wherein chemical bond lengths of M¹-N and M²-N calculated from a lattice constants and atomic coordinates in the crystal structure of said fluorescent substance are within the range of ±15% based on those of Al—N and Si—N, respectively, calculated from the lattice constants and atomic coordinates of Sr₂Al₃Si₇ON₁₃; and

the fluorescent substance (R) emits luminescence having a peak in the wavelength range of 580 to 650 nm when excited with light given by said light-emitting chip (S1); and

a fluorescent substance (G) comprising an inorganic compound which comprises:

a metal element M′,
an element M′¹ selected from the group of trivalent elements other than said metal element M′,
an element M′² selected from the group of tetravalent elements other than said metal element M′, and
nitrogen element,

said metal element M′ being partly replaced with a luminescent center element EC′;

wherein chemical bond lengths of M′¹-N and M′²-N calculated from a lattice constants and atomic coordinates in the crystal structure of said fluorescent substance are within the range of ±15% based on those of Al—N and Si—N, respectively, calculated from the lattice constants and atomic coordinates of Sr₃Al₃Si₁₃O₂N₂₁; and

the fluorescent substance (G) emits luminescence having a peak in the wavelength range of 490 to 580 nm when excited with light given by said light-emitting chip (S1).

Furthermore, another light-emitting device according to still another aspect of the present invention comprises

a light-emitting chip (S2) giving off light in the wavelength range of 250 to 430 nm;

a fluorescent substance (R) comprising an inorganic compound which comprises:

a metal element M,
an element M¹ selected from the group of trivalent elements other than said metal element M,
an element M² selected from the group of tetravalent elements other than said metal element M, and
nitrogen element,

said metal element M being partly replaced with a luminescent center element EC;

wherein chemical bond lengths of M¹-N and M²-N calculated from a lattice constants and atomic coordinates in the crystal structure of said fluorescent substance are within the range of ±15% based on those of Al—N and Si—N, respectively, calculated from the lattice constants and atomic coordinates of Sr₂Al₃Si₇ON₁₃; and

the fluorescent substance (R) emits luminescence having a peak in the wavelength range of 580 to 650 nm when excited with light given by said light-emitting chip (S2);

a fluorescent substance (G) comprising an inorganic compound which comprises:

a metal element M′,
an element M′¹ selected from the group of trivalent elements other than said metal element M′,
an element M′² selected from the group of tetravalent elements other than said metal element M′, and
nitrogen element,

said metal element M′ being partly replaced with a luminescent center element EC′;

wherein chemical bond lengths of M′¹-N and M′²-N calculated from a lattice constants and atomic coordinates in the crystal structure of said fluorescent substance are within the range of ±15% based on those of Al—N and Si—N, respectively, calculated from the lattice constants and atomic coordinates of Sr₃Al₃Si₁₃O₂N₂₁; and
the fluorescent substance (G) emits luminescence having a peak in the wavelength range of 490 to 580 nm when excited with light given by said light-emitting chip (S2); and

a fluorescent substance (B) which emits luminescence having a peak in the wavelength range of 400 to 490 nm when excited with light given by said light-emitting chip (S2).

The present invention provides a red fluorescent substance having excellent quantum efficiency and hence giving high emission intensity. This emission intensity is prevented from lowering even if the temperature is elevated. Further, the present invention also provides a light-emitting device which less undergoes color drift even when working with high power. Since light emitted from the device less suffers from color drift, namely, from color change, the light-emitting device according to the present invention is very practically advantageous.

### BRIEF DESCRIPTION OF THE DRAWINGS

FIG. 1 is a schematic sectional view of the light-emitting device utilizing a fluorescent substance according to one aspect of the present invention.

FIG. 2 is an XRD profile of Sr₂Al₃Si₇ON₁₃.

FIG. 3 illustrates the crystal structure of Sr₂Al₃Si₇ON₁₃, and (a), (b) and (c) are projections of the crystal structure along the c, b and a axes, respectively.

FIG. 4 shows emission spectra given by the red fluorescent substances of Examples 1 to 4 under the excitation with light at 460 nm.

FIG. 5 is a graph showing temperature characteristics of the fluorescent substances used in Example 1.

FIG. 6 is a schematic sectional view of the light-emitting device in Example 1.

FIG. 7 shows an emission spectrum given by the light-emitting device in Example 1.

FIG. 8 is a graph showing the correlation between drive current and chromaticity (two-degree field) of the light-emitting device in Example 1.

FIG. 9 shows an emission spectrum given by the light-emitting device in Example 2.

FIG. 10 is a graph showing the correlation between drive current and chromaticity (two-degree field) of the light-emitting device in Example 2.

FIG. 11 shows an emission spectrum given by the light-emitting device in Example 3.

FIG. 12 is a graph showing the correlation between drive current and chromaticity (two-degree field) of the light-emitting device in Example 3.

FIG. 13 shows an emission spectrum given by the light-emitting device in Example 4.

FIG. 14 is a graph showing the correlation between drive current and chromaticity (two-degree field) of the light-emitting device in Example 4.

FIG. 15 is a graph showing temperature characteristics of the fluorescent substances used in Example 5.

FIG. 16 shows an emission spectrum given by the light-emitting device in Example 6.

FIG. 17 is a graph showing the correlation between drive current and chromaticity (two-degree field) of the light-emitting device in Example 6.

FIG. 18 shows an emission spectrum given by the light-emitting device in Example 5.

FIG. 19 is a graph showing the correlation between drive current and chromaticity (two-degree field) of the light-emitting device in Example 5.

FIG. 20 shows an emission spectrum given by the light-emitting device in Example 7.

FIG. 21 is a graph showing the correlation between drive current and chromaticity (two-degree field) of the light-emitting device in Example 7.

FIG. 22 shows an emission spectrum given by the light-emitting device in Example 8.

FIG. 23 is a graph showing the correlation between drive current and chromaticity (two-degree field) of the light-emitting device in Example 8.

FIG. 24 is a graph showing temperature characteristics of the fluorescent substances used in Example 9.

FIG. 25 shows an emission spectrum given by the light-emitting device in Example 9.

FIG. 26 is a graph showing the correlation between drive current and chromaticity (two-degree field) of the light-emitting device in Example 9.

FIG. 27 shows an emission spectrum given by the red fluorescent substance of Comparative Example 1 under the excitation with light at 460 nm.

FIG. 28 is a graph showing temperature characteristics of the fluorescent substances used in Comparative Example 1.

FIG. 29 shows an emission spectrum given by the light-emitting device in Comparative Example 1.

FIG. 30 is a graph showing the correlation between drive current and chromaticity (two-degree field) of the light-emitting device in Comparative Example 1.

FIG. 31 is a graph showing temperature characteristics of the fluorescent substances used in Comparative Example 2.

FIG. 32 shows an emission spectrum given by the light-emitting device in Comparative Example 2.

FIG. 33 is a graph showing the correlation between drive current and chromaticity (two-degree field) of the light-emitting device in Comparative Example 2.

### DETAILED DESCRIPTION OF THE INVENTION

The present inventors have found that a red fluorescent substance excellent both in quantum efficiency and in temperature characteristics can be obtained by incorporating a luminescent center element into an oxynitride compound having a particular crystal structure and a specific composition. Further, the present inventors have also found that a light-emitting device less suffering from color drift even when working with high power can be obtained by employing the above red fluorescent substance in combination with a particular green fluorescent substance.

The red fluorescent substance and the light-emitting device employing that substance according to the present invention are described below.

### Red Fluorescent Substance

The red fluorescent substance (R) according to the present invention emits luminescence having a peak in the wavelength range of 580 to 650 nm when excited with light in the wavelength range of 250 to 500 nm. This substance is characterized by containing an inorganic compound which comprises a metal element M, an element M¹ selected from the group of trivalent elements other than the metal element M, an element M² selected from the group of tetravalent elements other than the metal element M, and nitrogen element, and optionally oxygen element, said metal element M being partly replaced with a luminescent center element EC; and is also characterized in that the chemical bond lengths of M¹-N and M²-N calculated from the lattice constants and atomic coordinates in the crystal structure of the fluorescent substance are within the range of ±15% based on those of Al—N and Si—N, respectively, calculated from the lattice constants and atomic coordinates of Sr₂Al₃Si₇ON₁₃.

The metal element M is preferably selected from the IA (alkali metal) group elements such as Li, Na and K; the IIA (alkaline earth metal) group elements such as Mg, Ca, Sr and Ba; the IIIA group elements such as B, Ga and In; the IIIB group elements such as Y and Sc; the rare earth elements such as Gd, La and Lu; and the IVA group elements such as Ge. The metal element M may be either a single element or a combination of two or more elements.

The element M¹ is different from the metal element M, and is selected from the group of trivalent elements. The trivalent elements are preferably selected from the IIIA group elements and the IIIB group elements. Concrete examples of the element M¹ include Al, B, Ga, In, Sc, Y, La, Gd and Lu. The element M¹ may be either a single element or a combination of two or more elements.

The element M² is different from the metal element M, and is selected from the group of tetravalent elements. The tetravalent elements are preferably selected from the IVA group elements and the IVB group elements. Concrete examples of the element M² include Si, Ge, Sn, Ti, Zr and Hf. The element M² may be either a single element or a combination of two or more elements.

In the above, some elements are repeatedly included in the examples of the metal element M and the elements M¹ and M². However, the elements M¹ and M² in the fluorescent substance of the present invention are so selected that they are different from the metal element M.

The fluorescent substance according to the present invention has a crystal structure basically comprising the elements M, M¹, M² and N, and O (if exist), but it is necessary that the metal element M be partly replaced with a luminescent center element EC.

Examples of the luminescent center element EC include Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe. Among them, either or both of Eu and Mn can be preferably selected in consideration of emission wavelength variability and the like.

Preferably, 0.1 mol % or more of the metal element M is replaced with the luminescent center element EC. If the amount of the replaced M is less than 0.1 mol %, it is difficult to obtain sufficient emission intensity. The metal element M can be completely replaced with the luminescent center element EC. However, if the amount of the replaced M is less than 50 mol %, the decrease of emission probability (concentration quenching) can be prevented to the utmost. The red fluorescent substance (R) according to the present invention emits light in the range of yellow to red, namely, emits luminescence having a peak in the wavelength range of 580 to 650 nm under the excitation with light of 250 to 500 nm.

The red fluorescent substance used in the light-emitting device according to the present invention can be considered based on Sr₂Al₃Si₇ON₁₃, but its constituting elements Sr, Si, Al, O and N are replaced with other elements and/or the Sr₂Al₃Si₇ON₁₃ matrix is fused with other metal elements such as Eu to form a solid solution. These modifications such as replacement often change the crystal structure slightly. However, the atomic positions therein, which depend on such conditions as the crystal structure, the sites occupied by the atoms therein and their atomic coordinates, are seldom changed so greatly that the chemical bonds among the skeleton atoms are broken. This means that the red fluorescent substance of the present invention can give the effect of the present invention without changing the fundamental crystal structure. In the present invention, it is considered that the fundamental crystal structure is not changed as long as the modification is to the extent described below. In the case where the chemical bond lengths (close interatomic distances) of M¹-N and M²-N calculated from the lattice constants and atomic coordinates determined by X-ray diffraction or neutron diffraction are within the range of ±15% based on those of Al—N and Si—N, respectively, calculated from the lattice constants and atomic coordinates (shown in Table 1) of Sr₂Al₃Si₇ON₁₃, the fundamental crystal structure is thought not to be changed in the present invention. Accordingly, it is indispensable for the red fluorescent substance of the present invention to have the above crystal structure. If the chemical bond lengths are changed more than the above, they are broken to form another crystal structure and hence the effect of the present invention cannot be obtained.

TABLE 1

| | Site | SOF* | x | y | z |
|---|---|---|---|---|---|
| Sr1 | 4a | 1 | 0.2786 | 0.49060(11) | 0.5284(14) |
| Sr2 | 4a | 1 | 0.3552(3) | 0.69839(12) | 0.048(2) |
| Si/Al1 | 4a | 1 | 0.3582(9) | 0.2769(3) | 0.070(3) |
| Si/Al2 | 4a | 1 | 0.5782(9) | 0.7996(4) | 0.047(5) |
| Si/Al3 | 4a | 1 | 0.5563(8) | 0.4672(3) | 0.543(5) |
| Si/Al4 | 4a | 1 | 0.4724(8) | 0.6092(3) | 0.556(4) |
| Si/Al5 | 4a | 1 | 0.1910(7) | 0.6397(3) | 0.535(4) |
| Si/Al6 | 4a | 1 | 0.0061(8) | 0.5438(3) | 0.546(4) |
| Si/Al7 | 4a | 1 | 0.1625(9) | 0.5661(3) | 0.038(4) |
| Si/Al8 | 4a | 1 | 0.3937(8) | 0.3469(3) | 0.547(4) |
| Si/Al9 | 4a | 1 | 0.1552(18) | 0.3483(8) | 0.318(3) |
| Si/Al10 | 4a | 1 | 0.1525(14) | 0.3492(6) | 0.813(2) |
| O/N1 | 4a | 1 | 0.436(2) | 0.8164(10) | 0.061(11) |
| O/N2 | 4a | 1 | 0.699(2) | 0.4692(10) | 0.513(10) |
| O/N3 | 4a | 1 | 0.334(2) | 0.6355(10) | 0.511(9) |
| O/N4 | 4a | 1 | 0.213(2) | 0.2980(11) | 0.056(12) |
| O/N5 | 4a | 1 | 0.256(2) | 0.3750(10) | 0.563(9) |
| O/N6 | 4a | 1 | 0.894(2) | 0.6002(12) | 0.549(14) |
| O/N7 | 4a | 1 | 0.358(3) | 0.2062(12) | 0.893(6) |
| O/N8 | 4a | 1 | 0.508(2) | 0.4677(12) | 0.885(6) |
| O/N9 | 4a | 1 | 0.398(2) | 0.2727(12) | 0.392(6) |
| O/N10 | 4a | 1 | 0.430(3) | 0.3336(15) | 0.896(7) |
| O/N11 | 4a | 1 | 0.942(3) | 0.4814(15) | 0.371(8) |
| O/N12 | 4a | 1 | 0.662(2) | 0.8571(12) | 0.893(6) |
| O/N13 | 4a | 1 | 0.128(3) | 0.5743(15) | 0.381(7) |
| O/N14 | 4a | 1 | 0.495(3) | 0.3982(13) | 0.383(6) |

Remark) SOF* site occupation factor

A preferred example of the red fluorescent substance (R) according to the present invention is represented by the following formula (1):

(M₁₋ₓECₓ)ₐSi_{b}AlO_{c}N_{d} (1).

In the formula (1), M and EC are the same as described above and x, a, b, c and d are numbers satisfying the conditions of 0<x<0.4, 0.65<a<0.70, 2<b<3, 0.3<c<0.6 and 4<d<5, respectively. These conditions are preferably 0.02≦x≦0.2, 0.66≦a≦0.69, 2.2≦b≦2.4, 0.43≦c≦0.51 and 4.2≦d≦4.3, respectively.

The red fluorescent substance of the present invention is based on an inorganic compound having essentially the same crystal structure as Sr₂Al₃Si₇ON₁₃ provided that the constituting elements are partly replaced with luminous elements and that their contents are restricted in the predetermined ranges, whereby the fluorescent substance can have excellent quantum efficiency and such favorable temperature characteristics as to exhibit small thermal quenching when used in the light-emitting device.

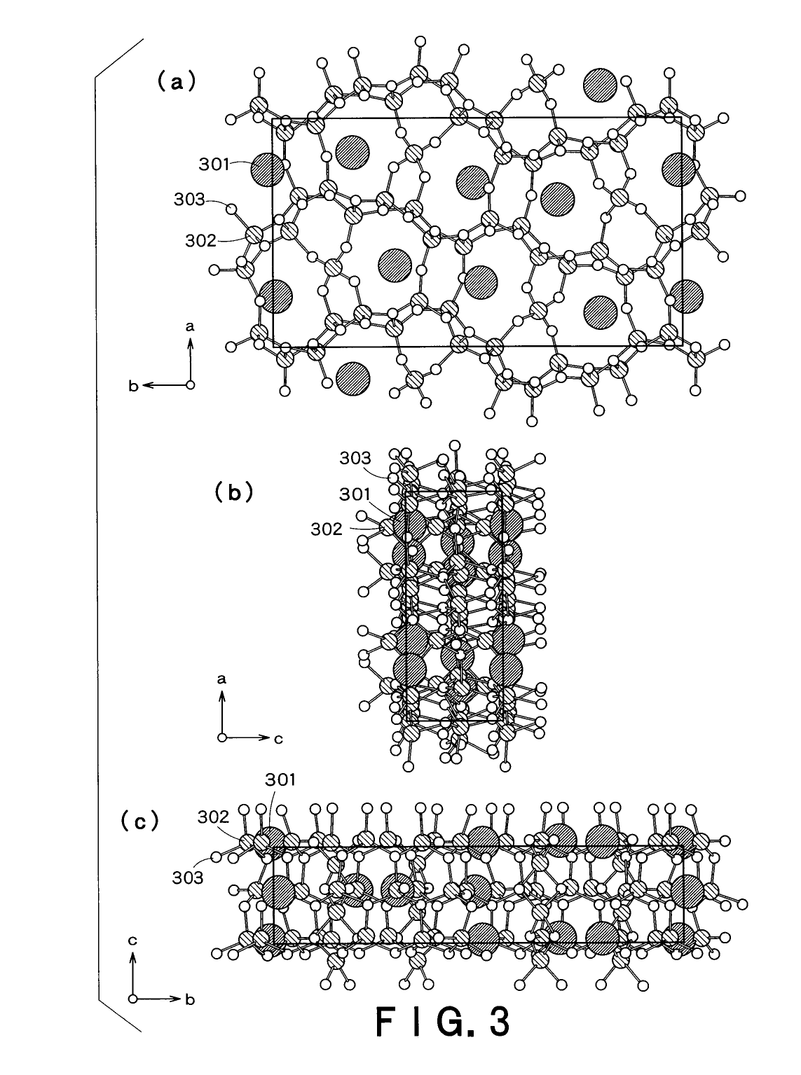

The crystal structure of Sr₂Al₃Si₇ON₁₃ belongs to a rhombic system with lattice constants of a=11.8033(13) Å, b=21.589(2) Å and c=5.0131(6) Å, and gives an XRD profile shown in FIG. 2. This crystal belongs to the space group Pna21 (which is the 164^{th} space group listed in International Table for Crystallography, Volume A: Space-group symmetry, Edited by T. Hahn, Springer (Netherlands)). Generally, according to single crystal XRD, it can be determined what space group the crystal belongs to. The crystal structure of Sr₂Al₃Si₇ON₁₃ is illustrated in FIG. 3.

The red fluorescent substance of the present invention can be identified by X-ray diffraction or neutron diffraction. The present invention includes not only a fluorescent substance exhibiting the same XRD profile as Sr₂Al₃Si₇ON₁₃, but also a compound in which the constituting elements of Sr₂Al₃Si₇ON₁₃ are so replaced with other elements as to change the lattice constants in the particular ranges. In other words, the red fluorescent substance according to the present invention includes a compound having the Sr₂Al₃Si₇ON₁₃ matrix crystal in which Sr is replaced with the element M and/or the luminescent center element EC; in which Si is replaced with one or more elements selected from the group of tetravalent elements such as Ge, Sn, Ti, Zr and Hf; in which Al is replaced with one or more elements selected from the group of trivalent elements such as B, Ga, In, Sc, Y, La, Gd and Lu; and in which O or N is replaced with one or more elements selected from the group consisting of O, N and C. Further, Al and Si may be substituted with each other and, at the same time, O and N may be substituted with each other. Examples of that compound include Sr₂Al₂Si₈N₁₄, Sr₂Al₄Si₆O₂N₁₂, Sr₂Al₅Si₅O₃N₁₁ and Sr₂Al₆Si₄O₄N₁₀. These compounds have crystal structures belonging to the same group as Sr₂Al₃Si₇ON₁₃.

In the case where the substitutional ratio is low, it can be judged by the following simple method whether the crystal belongs to the same group as Sr₂Al₃Si₇ON₁₃ or not. The XRD profile of the modified crystal is measured, and the positions of the diffraction peaks are compared with those in the XRD profile of Sr₂Al₃Si₇ON₁₃. As a result, if the positions of the main peaks are identical, their crystal structures can be regarded as the same. As the main peaks for comparison, it is preferred to select about 10 peaks having strong diffraction intensity.

### Green Fluorescent Substance

The green fluorescent substance (G) used in the present invention can be defined similarly to the aforementioned red fluorescent substance although they have different basic crystal structures.

The green fluorescent substance (G) is characterized by containing an inorganic compound which comprises a metal element M′, an element M′¹ selected from the group of trivalent elements other than the metal element M′, an element M′² selected from the group of tetravalent elements other than the metal element M′, and nitrogen element, and optionally oxygen element, said metal element M′ being partly replaced with a luminescent center element EC′; and is also characterized in that the chemical bond lengths of M′¹-N and M′²-N calculated from the lattice constants and atomic coordinates in the crystal structure of the fluorescent substance are within the range of ±15% based on those of Al—N and Si—N, respectively, calculated from the lattice constants and atomic coordinates of Sr₃Al₃Si₁₃O₂N₂₁.

The M′, M′¹, M′² and EC′ are selected from the same elements as the above-described M, M¹, M² and EC of the red fluorescent substance, respectively. The elements constituting the green fluorescent substance need not to be the same as those constituting the red one, and hence they can be independently selected.

The green fluorescent substance (G) used in the present invention emits light in the range of bluish green to yellowish green, namely, emits luminescence having a peak in the wavelength range of 490 to 580 nm under the excitation with light of 250 to 500 nm.

The green fluorescent substance (G) can be considered based on Sr₃Al₃Si₁₃O₂N₂₁. In the same manner as the red fluorescent substance described above, the effect of the present invention is obtained by modifications such as replacement of the constituting elements as long as the modifications do not change the fundamental crystal structure even if they cause minor changes. To what extent the modifications do not change the fundamental crystal structure is the same as the red fluorescent substance described above. In the case where the chemical bond lengths (close interatomic distances) of M′¹-N and M′²-N calculated from the lattice constants and atomic coordinates determined by X-ray diffraction or neutron diffraction are within the range of ±15% based on those of Al—N and Si—N, respectively, calculated from the lattice constants and atomic coordinates (shown in Table 2) of Sr₃Al₃Si₁₃O₂N₂₁, the fundamental crystal structure is thought not to be changed in the present invention. Accordingly, it is indispensable for the green fluorescent substance in the present invention to have the above crystal structure. If the chemical bond lengths are changed more than the above, they are broken to form another crystal structure and hence the effect of the present invention cannot be obtained.

TABLE 2

| | Site | SOF* | x | y | z |
|---|---|---|---|---|---|
| Sr1 | 4a | 1 | 0.2500 | 0.0000 | 0.1238(9) |
| Sr2 | 4a | 1 | 0.7667(11) | 0.1679(10) | 0.1312(8) |
| Sr3 | 4a | 1 | 0.7667(11) | 0.1679(10) | 0.6312(8) |
| Si1 | 4a | 0.5 | 0.0857(6) | 0.5274(3) | 0.2435(3) |
| Si2 | 4a | 0.5 | 0.4143(6) | 0.4726(3) | 0.2435(3) |
| Si3 | 4a | 0.5 | 0.0667(7) | 0.4709(4) | 0.2788(4) |
| Si4 | 4a | 0.5 | 0.4333(7) | 0.5291(4) | 0.2788(4) |
| Si5 | 4a | 1 | 0.1015(3) | 0.4497(2) | 0.0665(2) |
| Si6 | 4a | 1 | 0.3985(3) | 0.5503(2) | 0.0665(2) |
| Si7 | 4a | 1 | 0.9397(3) | 0.3398(2) | 0.2221(2) |
| Si8 | 4a | 1 | 0.5603(3) | 0.6602(2) | 0.2221(2) |
| Si9 | 4a | 1 | 0.0866(3) | 0.1586(2) | 0.2440(2) |
| Si10 | 4a | 1 | 0.4134(3) | 0.8414(2) | 0.2440(2) |
| Si11 | 4a | 1 | 0.9007(3) | 0.1506(2) | 0.4277(2) |
| Si12 | 4a | 1 | 0.5993(3) | 0.8494(2) | 0.4277(2) |
| Si13 | 4a | 1 | 0.9038(3) | 0.3520(19) | 0.4313(2) |
| Si14 | 4a | 1 | 0.5962(3) | 0.6480(19) | 0.4313(2) |
| Si15 | 4a | 1 | 0.1025(3) | 0.0525(19) | 0.0691(2) |
| Si16 | 4a | 1 | 0.3975(3) | 0.9475(19) | 0.0691(2) |
| Si17 | 4a | 1 | 0.6052(3) | 0.2491(2) | 0.4346(2) |
| Si18 | 4a | 1 | 0.8948(3) | 0.7509(8) | 0.4346(2) |
| N1 | 4a | 1 | 0.9936(9) | 0.3559(8) | 0.3289(6) |
| N2 | 4a | 1 | 0.5064(9) | 0.6441(8) | 0.3289(6) |
| N3 | 4a | 1 | 0.2500 | 0.5000 | 0.2960(1) |
| N4 | 4a | 1 | 0.0171(10) | 0.4419(5) | 0.1733(6) |
| N5 | 4a | 1 | 0.4829(10) | 0.5581(5) | 0.1733(6) |
| N6 | 4a | 1 | 0.7456(8) | 0.6671(7) | 0.2049(6) |
| N7 | 4a | 1 | 0.7544(8) | 0.3329(7) | 0.2049(6) |
| N8 | 4a | 1 | 0.2110(2) | 0.5458(11) | 0.0630(1) |
| N9 | 4a | 1 | 0.4760(18) | 0.4535(14) | 0.0120(1) |
| N10 | 4a | 1 | 0.5322(19) | 0.5488(11) | 0.4870(1) |
| N11 | 4a | 1 | 0.5320(2) | 0.7498(14) | 0.4870(1) |
| N12 | 4a | 1 | 0.7943(18) | 0.2494(11) | 0.4400(1) |
| N13 | 4a | 1 | 0.4706(19) | 0.8488(11) | 0.0100(1) |
| N14 | 4a | 1 | 0.7901(18) | 0.8475(16) | 0.4500(1) |
| N15 | 4a | 1 | 0.5442(19) | 0.1508(12) | 0.4920(1) |
| N16 | 4a | 1 | 0.0407(11) | 0.0624(6) | 0.1785(6) |
| N17 | 4a | 1 | 0.4593(11) | 0.9376(6) | 0.1785(6) |
| N18 | 4a | 1 | 0.0514(12) | 0.6421(7) | 0.1812(7) |
| N19 | 4a | 1 | 0.0316(12) | 0.2506(7) | 0.1742(6) |
| N20 | 4a | 1 | 0.7881(19) | 0.6483(12) | 0.4380(1) |
| N21 | 4a | 1 | 0.7897(17) | 0.4504(10) | 0.4460(1) |
| N22 | 4a | 1 | 0.4486(12) | 0.3579(7) | 0.1812(7) |
| N23 | 4a | 1 | 0.4684(12) | 0.7494(7) | 0.1742(6) |

Remark) SOF* site occupation factor

An example of the green fluorescent substance (G) according to the present invention is represented by the following formula (2):

(M′₁₋ₓEC′ₓ)_{3-y}Al_{3+z}Si_{13-z}O₂₊ᵤN_{21-w} (2)

In the formula (2), M′ is an element selected from the IA group elements, the IIA group elements, the IIIA group elements, the IIIB group elements, the rare earth elements and the IVA group elements; EC′ is an element selected from the group consisting of Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe; and x, y, z, u and w are numbers satisfying the conditions of 0<≦x≦1, −0.1≦y≦0.15, −1≦z≦1 and −1<u−w≦1, respectively. These conditions are preferably 0.001≦x≦0.5, −0.09≦y≦0.07, 0.2≦z≦1 and −0.1≦u−w≦0.3, respectively.

The green fluorescent substance (G) in the present invention is based on an inorganic compound having essentially the same crystal structure as Sr₃Al₃Si₁₃O₂N₂₁ provided that the constituting elements are partly replaced with luminous elements and that their contents are restricted in the predetermined ranges, whereby the fluorescent substance can have excellent quantum efficiency.

The crystal structure of Sr₃Al₃Si₁₃O₂N₂₁ belongs to a rhombic system.

The green fluorescent substance of the present invention can be identified by X-ray diffraction or neutron diffraction. The present invention includes not only a fluorescent substance exhibiting the same XRD profile as Sr₃Al₃Si₁₃O₂N₂₁, but also a compound in which the constituting elements of Sr₃Al₃Si₁₃O₂N₂₁ are so replaced with other elements as to change the lattice constants in the particular ranges. In other words, the green fluorescent substance according to the present invention includes a compound having the Sr₃Al₃Si₁₃O₂N₂₁ matrix crystal in which Sr is replaced with the element M′ and/or the luminescent center element EC′; in which Si is replaced with one or more elements selected from the group of tetravalent elements such as Ge, Sn, Ti, Zr and Hf; in which Al is replaced with one or more elements selected from the group of trivalent elements such as B, Ga, In, Sc, Y, La, Gd and Lu; and in which O or N is replaced with one or more elements selected from the group consisting of O, N and C. Further, Al and Si may be substituted with each other and, at the same time, O and N may be substituted with each other. Examples of that compound include Sr₃Al₂Si₁₄ON₂₂, Sr₃AlSi₁₅N₂₃, Sr₃Al₄Si₁₂O₃N₂₀, Sr₃Al₅Si₁₁O₄N₁₉ and Sr₃Al₆Si₁₀O₅N₁₈. These compounds have crystal structures belonging to the same group as Sr₃Al₃Si₁₃O₂N₂₁.

In the case where the substitutional ratio is low, it can be judged by the same simple method as described above for the red fluorescent substance whether the crystal belongs to the same group as Sr₃Al₃Si₁₃O₂N₂₁ or not.

### Synthesis of Red and Green Fluorescent Substances

The red or green fluorescent substance of the present invention can be synthesized from starting materials, which are, for example, a nitride of the element M (or M′) or a carbide thereof such as cyanamide; nitrides, oxides or carbides of the element M¹ (or M′¹) such as Al and the element M² (or M′²) such as Si; and an oxide, nitride or carbonate of the luminescent center element EC (or EC′). In the case where Sr as the element M (or M′) and Eu as the luminescent center element EC (or EC′) are intended to be incorporated, it is possible to adopt Sr₃N₂, AlN, Si₃N₄, Al₂O₃ and EuN as the starting materials. It is also possible to substitute Sr₃N₂ with Ca₃N₂, Ba₃N₂, Sr₂N, SrN or mixtures thereof. These materials are weighed and mixed so that the aimed composition can be obtained, and then the mixture is fired to synthesize the aimed fluorescent substance. The materials are mixed, for example, in a mortar in a glove box. The mixture can be fired in a crucible made of boron nitride, silicon nitride, silicon carbide, carbon, aluminum nitride, SiAlON, aluminum oxide, molybdenum or tungsten.

The mixture of the starting materials is fired for a predetermined time to obtain a red or green fluorescent substance having the aimed composition. The firing is preferably carried out under a pressure more than the atmospheric pressure. In order to prevent the silicon nitride from decomposing at a high temperature, the pressure is preferably not less than 5 atmospheres. The firing temperature is preferably in the range of 1500 to 2000° C., more preferably in the range of 1800 to 2000° C. If the temperature is lower than 1500° C., it is often difficult to obtain the aimed fluorescent substance. On the other hand, if the temperature is higher than 2000° C., there is a fear that the materials or the product may be sublimated. Further, since the material AlN is liable to be oxidized, the firing is preferably carried out under N₂ atmosphere. In that case, N₂—H₂ mixed gas atmosphere is also usable.

The fired product in the form of powder is then subjected to after-treatment such as washing, if necessary, to obtain a fluorescent substance as an embodiment of the present invention. The washing can be performed, for example, by the use of pure water or acid.

### Blue Fluorescent Substance

As described later, the light-emitting device according to the present invention employs the above red and green fluorescent substances in combination. The light-emitting device can further employ a blue fluorescent substance in combination. The blue fluorescent substance is not particularly restricted as long as it emits luminescence having a peak in the wavelength range of 400 to 490 nm.

However, if the blue fluorescent substance has poor temperature characteristics, the chromaticity of the resultant light often shifts to yellowish color according as the input power increases to elevate the temperature. This may be a problem particularly when white light is desired. Accordingly, from the viewpoint of the object of the present invention, namely, in order to provide a light-emitting device less suffering from color drift, the blue fluorescent substance preferably has as good temperature characteristics as the red and green fluorescent substances. Preferred examples of the blue fluorescent substance include (Ba,Eu)MgAl₁₀O₁₇, (Sr, Ca,Ba,Eu)₁₀(PO₄)₅Cl₂, and (Sr,Eu)Si₉Al₁₉ON₃ᵢ.

### Light-Emitting Device

The light-emitting device according to the present invention comprises the aforementioned fluorescent substances and a light-emitting chip capable of exciting them.

The light-emitting device as an embodiment of the present invention comprises a light-emitting chip of LED as an excitation light source and a combination of the above-described red and green fluorescent substances (R) and (G), which emit luminescence when excited with light emitted from the LED. Consequently, this light-emitting device gives off light of synthesized emissions from the LED and the red and green fluorescent substances.

The light-emitting device as another embodiment of the present invention comprises a light-emitting chip of LED as an excitation light source and a combination of the above-described red, green and blue fluorescent substances (R), (G) and (B), which emit luminescence when excited with light emitted from the LED.

In any embodiment of the present invention, it is indispensable for the light-emitting device to comprise a particular red fluorescent substance (R) and a particular green fluorescent substance (G) in combination. This combination ensures the balance between red and green components of light given off from the light-emitting device while working, and hence prevents the light from color drift. Further, those particular fluorescent substances undergo small thermal quenching while the light-emitting device is working, and accordingly their red and green luminescence can keep the balance with blue emission from the LED and/or from the blue fluorescent substance stably enough to reduce the color drift.

Since both of the red and green fluorescent substances undergo small thermal quenching, the present invention can realize a light-emitting device capable of giving off light in which red and green components are less likely to vary even when the device works with high power. Further, since those two fluorescent substances undergo thermal quenching at the same level in the temperature range of room temperature to approx. 200° C., the light-emitting device less suffers from color drift of red and green components even when the device works with high power to be heated. Although it is possible to produce a light-emitting device employing red and green fluorescent substances different from those defined in the present invention, the device produced thus generally cannot have the effect of the invention. In other words, it is generally impossible to prevent the color drift in that case.

The blue fluorescent substance is preferably incorporated in the device of the present invention since the color drift can be further reduced, provided that it undergoes thermal quenching at the same level as the red and green fluorescent substances. However, as for the wavelength range of luminescence, the blue fluorescent substance does not need to be restricted as strictly as the red or green one. That is because the luminescence emitted from the blue fluorescent substance can be compensated by the emission from the light-emitting chip of LED.

The light-emitting chip used in the light-emitting device is properly selected according to the fluorescent substances used together in the device. It is necessary for the light-emitting chip to emit light capable of exciting the fluorescent substances. Further, in the case where the light-emitting device is wanted to give off white light, the light-emitting chip preferably emit light capable of compensating luminescence from the fluorescent substances.

In consideration of the above, the light-emitting chip (S1) is so selected that it emits light in the wavelength range of 250 to 500 nm in the case where the red and green fluorescent substances are used in the device. On the other hand, if the red, green and blue fluorescent substances are used, the light-emitting chip (S2) is so selected that it emits light in the wavelength range of 250 to 430 nm.

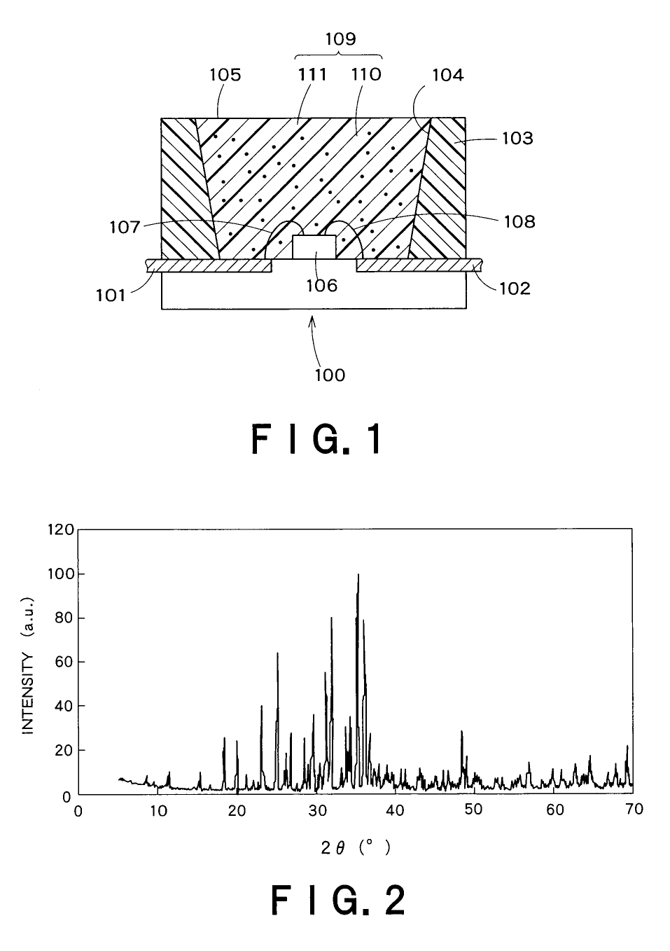

The light-emitting device according to the present invention can be in any type of conventionally known light-emitting devices. FIG. 1 is a schematic sectional view of the light-emitting device as an embodiment of the present invention.

In the light-emitting device shown in FIG. 1, a resin stem 100 comprises leads 101 and 102 molded as parts of a lead frame and also comprises a resin member 103 formed by unified molding together with the lead frame. The resin member 103 has a concavity 105 in which the top opening is larger than the bottom. On the inside wall of the concavity, a reflective surface 104 is provided.

At the center of the nearly circular bottom of the concavity 105, a light-emitting chip 106 is mounted with Ag paste or the like. Examples of the light-emitting chip 106 include a light-emitting diode and a laser diode. The light-emitting chip may emit ultraviolet light. There is no particular restriction on the light-emitting chip. Accordingly, it is also possible to adopt a chip capable of emitting blue, bluish violet or near ultraviolet light as well as ultraviolet light. For example, semiconductor light-emitting chips such as GaN can be used. The electrodes (not shown) of the light-emitting chip 106 are connected to the leads 101 and 102 by way of bonding wires 107 and 108 made of Au or the like, respectively. The positions of the leads 101 and 102 can be adequately changed.

In the concavity 105 of the resin member 103, a phosphor layer 109 is provided. For forming the phosphor layer 109, mixture of the fluorescent substances 110 according to the present invention may be dispersed or precipitated in a resin layer 111 made of silicone resin or the like in an amount of 5 to 50 wt. %. The fluorescent substance of the present invention comprises an oxynitride matrix having high covalency, and hence is generally so hydrophobic that it has good compatibility with the resin. Accordingly, scattering at the interface between the resin and the fluorescent substance is prevented enough to improve the light-extraction efficiency.

The light-emitting chip 106 may be a flip chip type in which an n-type electrode and a p-type one are placed on the same plane. This chip can avoid troubles concerning the wires, such as disconnection or dislocation of the wires and light-absorption by the wires. In that case, therefore, a semiconductor light-emitting device excellent both in reliability and in luminance can be obtained. Further, it is also possible to employ an n-type substrate in the light-emitting chip 106 so as to produce a light-emitting device constituted as described below. In the device, an n-type electrode is formed on the back surface of the n-type substrate while a p-type electrode is formed on the top surface of the semiconductor layer on the substrate. One of the n-type and p-type electrodes is mounted on one of the leads, and the other electrode is connected to the other lead by way of a wire. The size of the light-emitting chip 106 and the dimension and shape of the concavity 105 can be properly changed.

The light-emitting device as an embodiment of the present invention is not restricted to the package cup type as shown in FIG. 1, and can be freely applied to any type of devices. For example, even if the fluorescent substance of the present invention is used in a shell-type LED or in a surface-mount type LED, the same effect of the present invention can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

The present invention is further explained in detail by the following examples, which by no means restrict the present invention.

### Example 1

As the starting materials, Sr₃N₂, EuN, Si₃N₄, Al₂O₃ and AlN in the amounts of 2.676 g, 0.398 g, 6.080 g, 0.680 g and 0.683 g, respectively, were weighed and dry-mixed in an agate mortar in a vacuum glove box. The mixture was placed in a BN crucible and then fired at 1850° C. for 4 hours under 7.5 atm of N₂ atmosphere, to synthesize a fluorescent substance (G1) whose designed composition was (Sr_{0.92}Eu_{0.08})₃Al₃Si₁₃O₂N₂₁.

The fluorescent substance (G1) obtained by firing was in the form of yellowish green powder, and was observed to emit green luminescence when excited by black light.

Independently, as the starting materials, Sr₃N₂, EuN, Si₃N₄, Al₂O₃ and AlN in the amounts of 2.579 g, 0.232 g, 4.583 g, 0.476 g and 1.339 g, respectively, were weighed and dry-mixed in an agate mortar in a vacuum glove box. The mixture was placed in a BN crucible and then fired at 1850° C. for 4 hours under 7.5 atm of N₂ atmosphere, to synthesize a fluorescent substance (R1) whose designed composition was (Sr_{0.95}Eu_{0.05})₂Al₃SI₇ON₁₃.

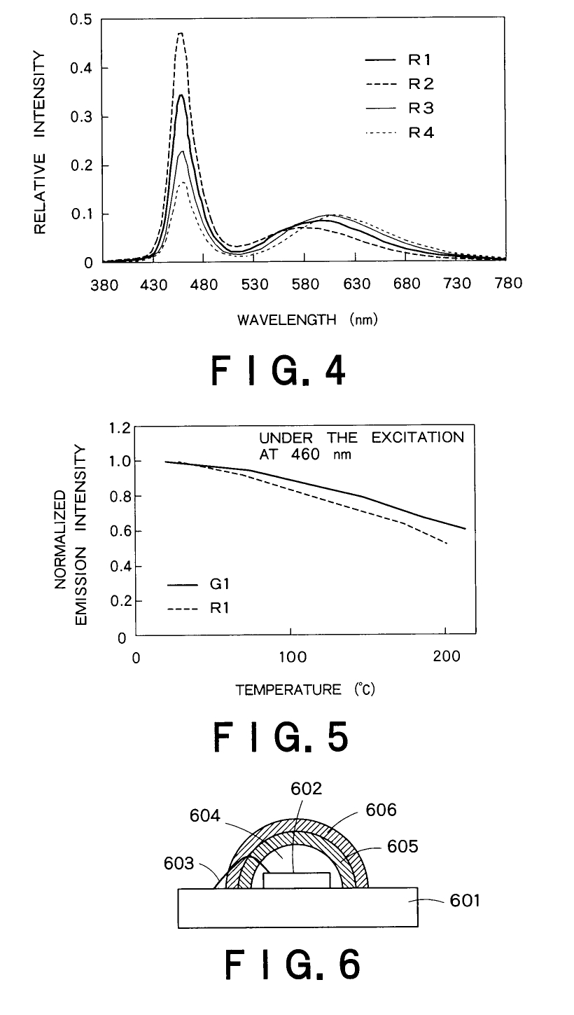

The fluorescent substance (R1) obtained by firing was in the form of orange powder, and was observed to emit red luminescence when excited by black light. The emission spectrum of the obtained red fluorescent substance under the excitation at 457 nm was shown in FIG. 4, and the result of component analysis (in terms of molar ratio normalized based on the Al content) was summarized in Table 3. Further, with respect to intensity of the emissions from the red and green fluorescent substances, the temperature dependence thereof was shown in FIG. 5 provided that the intensity at room temperature was normalized at 1.

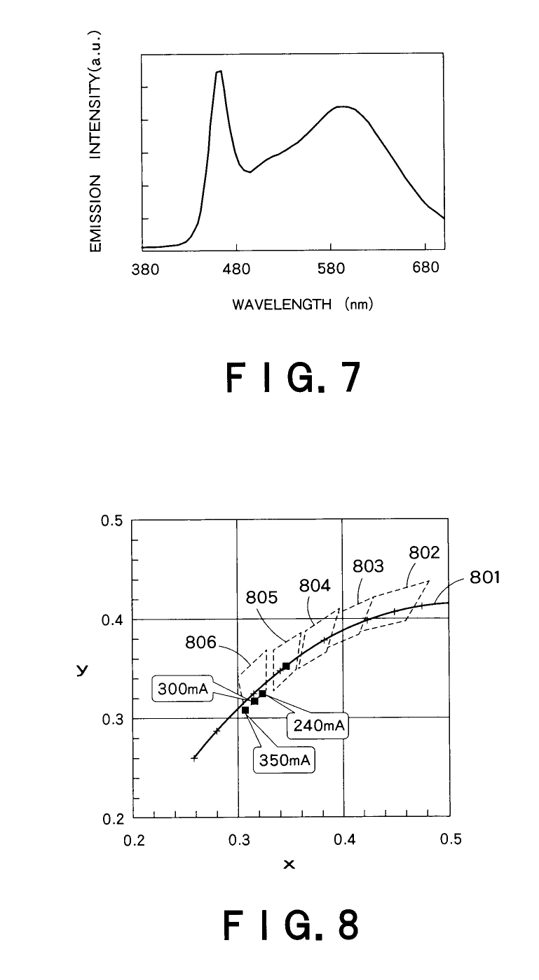

A light-emitting diode 602 giving an emission peak at 455 nm was soldered on an 8 mm-square AlN package 601, and was connected to electrodes by way of gold wires 603. The light-emitting diode was then domed with transparent resin 604, and the dome was coated with a layer of transparent resin 605 containing 30 wt. % of the red fluorescent substance (R1) giving an emission peak at 598 nm. Further, another layer of transparent resin 606 containing 30 wt. % of the green fluorescent substance (G1) was provided thereon. Thus, a light-emitting device (shown in FIG. 6) was produced. The produced device was placed in an integrating sphere, and then worked under the conditions of 20 mA and 3.1 V. The emitted light was observed to have the chromaticity of (0.345, 0.352), the color temperature of 5000K, the luminous efficacy of 67.9 Lm/W and Ra=86. The emission spectrum of the light-emitting device was shown in FIG. 7.

While the drive current was gradually increased up to 350 mA, the emission properties of the obtained device were measured in the above manner. The result was shown in FIG. 8. As shown in FIG. 8, the chromaticity varied to such a small extent that it did not deviate from the range regulated by JIS even when the drive current was 350 mA. The luminous efficacy and Ra value were 52.0 lm/W and Ra=79, respectively, at the drive current of 240 mA; 48.3 lm/W and Ra=77, respectively, at the drive current of 300 mA; and 43.9 lm/W and Ra=75, respectively, at the drive current of 350 mA. These results indicate that the luminous efficacy and Ra value varied only slightly.

### Example 2

The procedure of Example 1 was repeated to synthesize the green fluorescent substance (G1). Thereafter, the procedure of Example 1 was further repeated except for changing the amounts of Sr₃N₂ and EuN into 2.660 g and 0.093 g, respectively, to synthesize a red fluorescent substance (R2) whose designed composition was (Sr_{0.98}Eu_{0.02})₂Al₃Si₇ON₁₃. The emission spectrum of the obtained red fluorescent substance (R2) under the excitation at 457 nm was shown in FIG. 4, and the result of component analysis (in terms of molar ratio normalized based on the Al content) was summarized in Table 3.

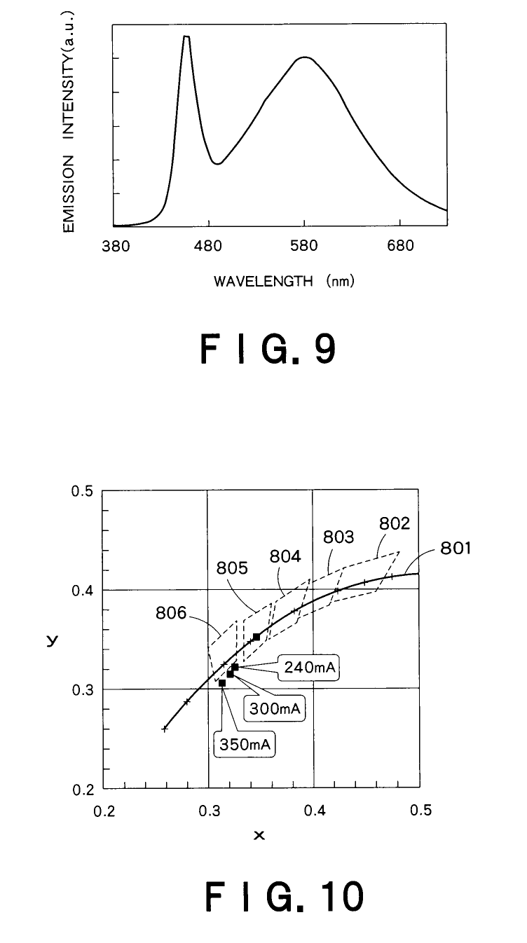

A light-emitting diode giving an emission peak at 455 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R2) giving an emission peak at 577 nm. Further, another layer of transparent resin containing 30 wt. % of the green fluorescent substance (G1) was provided thereon. Thus, a light-emitting device (shown in FIG. 6) was produced. The produced device was placed in an integrating sphere, and then worked under the conditions of 20 mA and 3.1 V. The emitted light was observed to have the chromaticity of (0.345, 0.352), the color temperature of 5000K, the luminous efficacy of 73.8 lm/W and Ra=79. The emission spectrum of the light-emitting device was shown in FIG. 9.

While the drive current was gradually increased up to 350 mA, the emission properties of the obtained device were measured in the above manner. The result was shown in FIG. 10. As shown in FIG. 10, the chromaticity varied to a small extent. The luminous efficacy and Ra value were 56.8 lm/W and Ra=78, respectively, at the drive current of 240 mA; 53.5 lm/W and Ra=77, respectively, at the drive current of 300 mA; and 49.1 lm/W and Ra=76, respectively, at the drive current of 350 mA. These results indicate that the luminous efficacy and Ra value varied only slightly.

### Example 3

The procedure of Example 1 was repeated to synthesize the green fluorescent substance (G1). Thereafter, the procedure of Example 1 was further repeated except for changing the amounts of Sr₃N₂ and EuN into 2.443 g and 0.465 g, respectively, to synthesize a red fluorescent substance (R3) whose designed composition was (Sr_{0.9}Eu_{0.1})₂Al₃Si₇ON₁₃. The emission spectrum of the obtained red fluorescent substance (R3) under the excitation at 457 nm was shown in FIG. 4, and the result of component analysis (in terms of molar ratio normalized based on the Al content) was summarized in Table 3.

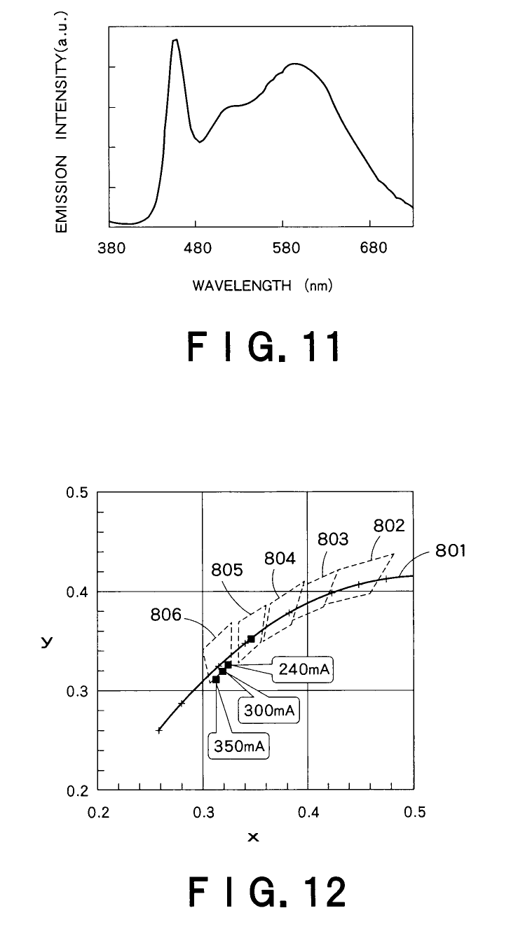

A light-emitting diode giving an emission peak at 455 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R3) giving an emission peak at 607 nm. Further, another layer of transparent resin containing 30 wt. % of the green fluorescent substance (G1) was provided thereon. Thus, a light-emitting device (shown in FIG. 6) was produced. The produced device was placed in an integrating sphere, and then worked under the conditions of 20 mA and 3.1 V. The emitted light was observed to have the chromaticity of (0.345, 0.352), the color temperature of 5000K, the luminous efficacy of 64.8 lm/W and Ra=90. The emission spectrum of the light-emitting device working at the drive current of 20 mA was shown in FIG. 11.

While the drive current was gradually increased up to 350 mA, the emission properties of the obtained device were measured in the above manner. The result was shown in FIG. 12. As shown in FIG. 12, the chromaticity varied to such a small extent that it did not deviate from the range regulated by JIS even when the drive current was 350 mA. The luminous efficacy and Ra value were 51.0 lm/W and Ra=85, respectively, at the drive current of 240 mA; 48.0 lm/W and Ra=84, respectively, at the drive current of 300 mA; and 44.3 lm/W and Ra=82, respectively, at the drive current of 350 mA. These results indicate that the luminous efficacy and Ra value varied only slightly.

### Example 4

The procedure of Example 1 was repeated to synthesize the green fluorescent substance (G1). Thereafter, the procedure of Example 1 was further repeated except for changing the amounts of Sr₃N₂ and EuN into 2.308 g and 0.697 g, respectively, to synthesize a red fluorescent substance (R4) whose designed composition was (Sr_{0.85}Eu_{0.15})₂Al₃Si₇ON₁₃. The emission spectrum of the obtained red fluorescent substance (R4) under the excitation at 457 nm was shown in FIG. 4, and the result of component analysis (in terms of molar ratio normalized based on the Al content) was summarized in Table 3. A light-emitting diode giving an emission peak at 455 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R4) giving an emission peak at 615 nm. Further, another layer of transparent resin containing 30 wt. % of the green fluorescent substance (G1) was provided thereon. Thus, a light-emitting device was produced. The produced device was placed in an integrating sphere, and then worked under the conditions of 20 mA and 3.1 V. The emitted light was observed to have the chromaticity of (0.345, 0.352), the color temperature of 5000K, the luminous efficacy of 57.2 lm/W and Ra=92. The emission spectrum of the light-emitting device working at the drive current of 20 mA was shown in FIG. 13.

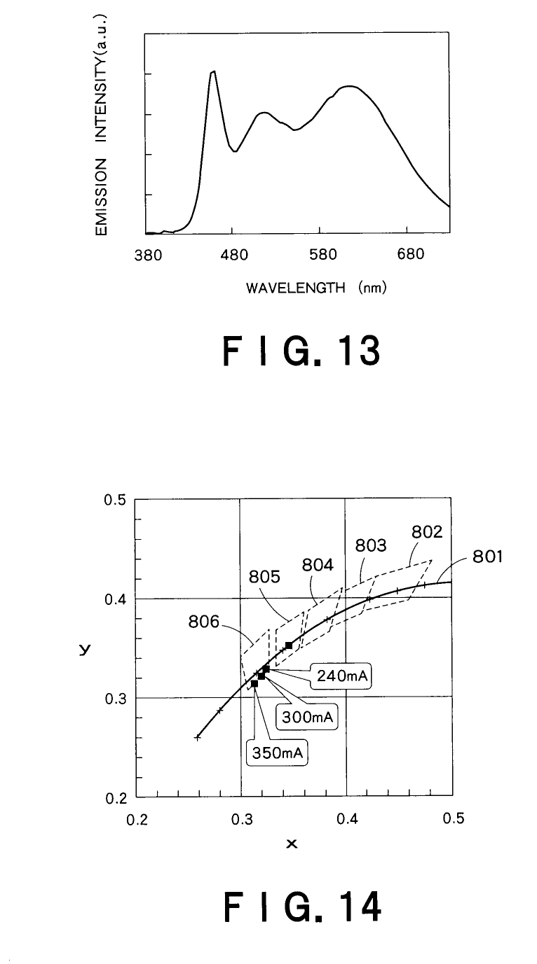

While the drive current was gradually increased up to 350 mA, the emission properties of the obtained device were measured in the above manner. The result was shown in FIG. 14. As shown in FIG. 14, the chromaticity varied to such a small extent that it did not deviate from the range regulated by

JIS even when the drive current was 350 mA. The luminous efficacy and Ra value were 45.4 lm/W and Ra=88, respectively, at the drive current of 240 mA; 42.8 lm/W and Ra=87, respectively, at the drive current of 300 mA; and 39.5 lm/W and Ra=85, respectively, at the drive current of 350 mA. These results indicate that the luminous efficacy and Ra value varied only slightly.

### Example 5

The procedure of Example 1 was repeated to synthesize the green fluorescent substance (G1). Thereafter, the procedure of Example 1 was further repeated except for changing only the firing atmosphere, to synthesize a red fluorescent substance (R5). A light-emitting diode giving an emission peak at 390 nm was soldered on an 8 mm-square AlN package, and was connected to electrodes by way of gold wires.

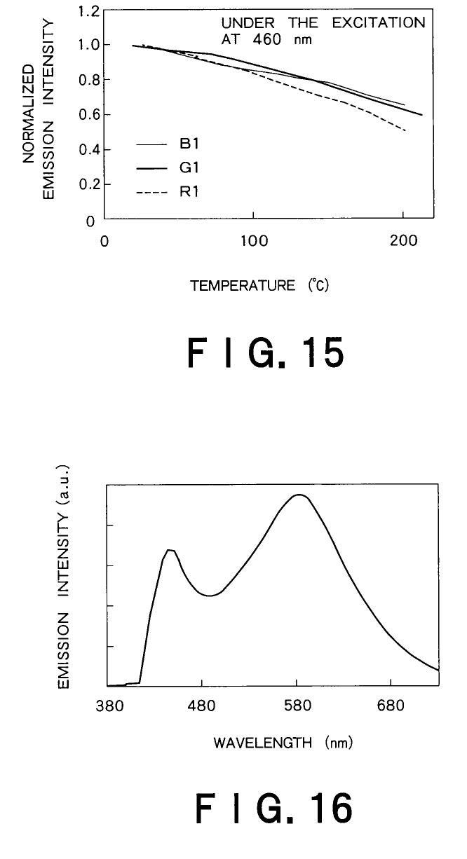

The light-emitting diode was then domed with transparent resin, and the dome was coated with a layer of transparent resin containing 30 wt. % of the red fluorescent substance (R5) giving an emission peak at 598 nm. Further, another layer of transparent resin containing 30 wt. % of the green fluorescent substance (G1) was provided thereon. Furthermore, still another layer of transparent resin containing 30 wt. % of a blue fluorescent substance (Ba_{0.9}Eu_{0.1})MgAl₁₀O₁₇ (B1) was provided thereon. Thus, a light-emitting device was produced. With respect to intensity of the emissions from the red, green and blue fluorescent substances (R5), (G1) and (B1), the temperature dependence thereof was shown in FIG. 15 provided that the intensity at room temperature was normalized at 1.

The produced device was placed in an integrating sphere, and then worked under the conditions of 20 mA and 3.1 V. The emitted light was observed to have the chromaticity of (0.345, 0.352), the color temperature of 5000K, the luminous efficacy of 62.39 lm/W and Ra=90. The emission spectrum of the light-emitting device was shown in FIG. 18.

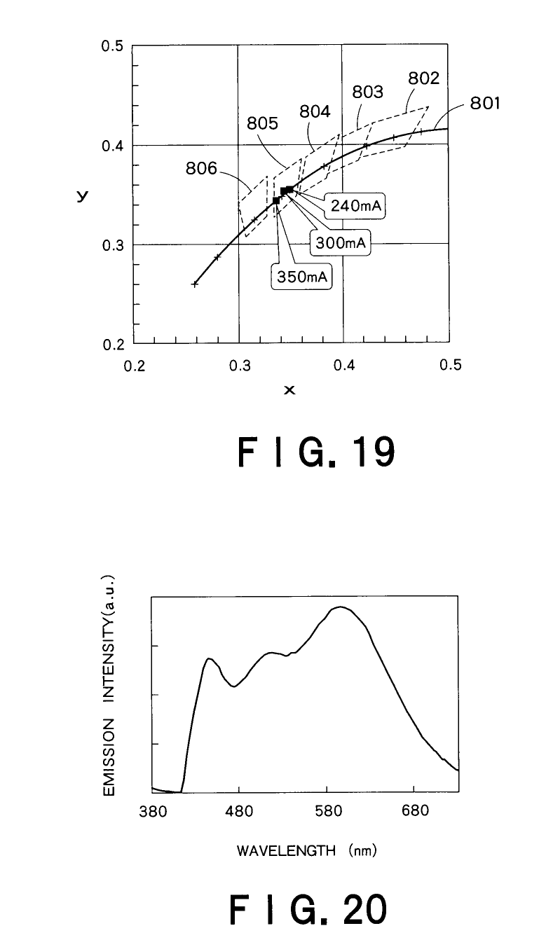

While the drive current was gradually increased up to 350 mA, the emission properties of the obtained device were measured in the above manner. The result was shown in FIG. 19. As shown in FIG. 19, the chromaticity varied to such a small extent that it did not deviate from the range of natural white regulated by JIS even when the drive current was 350 mA. The luminous efficacy, Ra value and chromaticity were 47.7 lm/W, Ra=89 and (x, y)=(0.341, 0.348), respectively, at the drive current of 240 mA; 44.7 lm/W, Ra=88 and (x, y)=(0.339, 0.349), respectively, at the drive current of 300 mA; and 41.5 lm/W, Ra=88 and (x, y)=(0.336, 0.347), respectively, at the drive current of 350 mA. These results indicate that the luminous efficacy, Ra value and chromaticity varied only slightly.

### Example 6

The procedure of Example 2 was repeated to synthesize the green fluorescent substance (G1). Thereafter, the procedure of Example 2 was further repeated except for changing only the firing atmosphere, to synthesize a red fluorescent substance (R6). A light-emitting diode giving an emission peak at 390 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R6) giving an emission peak at 577 nm. Further, another layer of transparent resin containing 30 wt. % of the green fluorescent substance (G1) was provided thereon. Furthermore, still another layer of transparent resin containing 30 wt. % of the blue fluorescent substance (B1) was provided thereon. Thus, a light-emitting device was produced.

The produced device was placed in an integrating sphere, and then worked under the conditions of 20 mA and 3.1 V. The emitted light was observed to have the chromaticity of (0.345, 0.352), the color temperature of 5000K, the luminous efficacy of 70.49 lm/W and Ra=81. The emission spectrum of the light-emitting device was shown in FIG. 16.

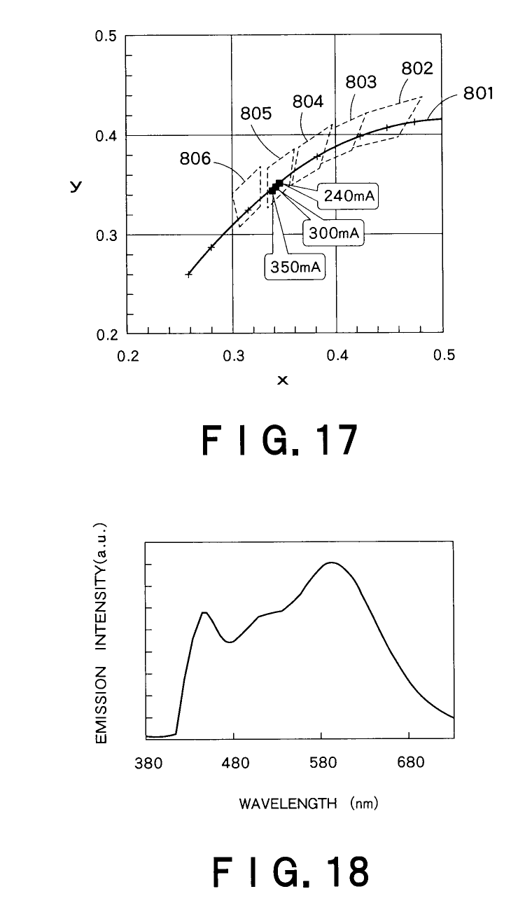

While the drive current was gradually increased up to 350 mA, the emission properties of the obtained device were measured in the above manner. The result was shown in FIG. 17. As shown in FIG. 17, the chromaticity varied to such a small extent that it did not deviate from the range of natural white regulated by JIS even when the drive current was 350 mA. The luminous efficacy, Ra value and chromaticity were 53.5 lm/W, Ra=81 and (x, y)=(0.341, 0.348), respectively, at the drive current of 240 mA; 50.2 lm/W, Ra=81 and (x, y)=(0.340, 0.346), respectively, at the drive current of 300 mA; and 46.1 lm/W, Ra=81 and (x, y)=(0.337, 0.343), respectively, at the drive current of 350 mA. These results indicate that the luminous efficacy, Ra value and chromaticity varied only slightly.

### Example 7

The procedure of Example 3 was repeated to synthesize the green fluorescent substance (G1). Thereafter, the procedure of Example 3 was further repeated except for changing only the firing atmosphere, to synthesize a red fluorescent substance (R7). A light-emitting diode giving an emission peak at 390 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R7) giving an emission peak at 607 nm. Further, another layer of transparent resin containing 30 wt. % of the green fluorescent substance (G1) was provided thereon. Furthermore, still another layer of transparent resin containing 30 wt. % of the blue fluorescent substance (B1) was provided thereon. Thus, a light-emitting device was produced.

The produced device was placed in an integrating sphere, and then worked under the conditions of 20 mA and 3.1 V. The emitted light was observed to have the chromaticity of (0.345, 0.352), the color temperature of 5000K, the luminous efficacy of 59.79 lm/W and Ra=92. The emission spectrum of the light-emitting device was shown in FIG. 20.

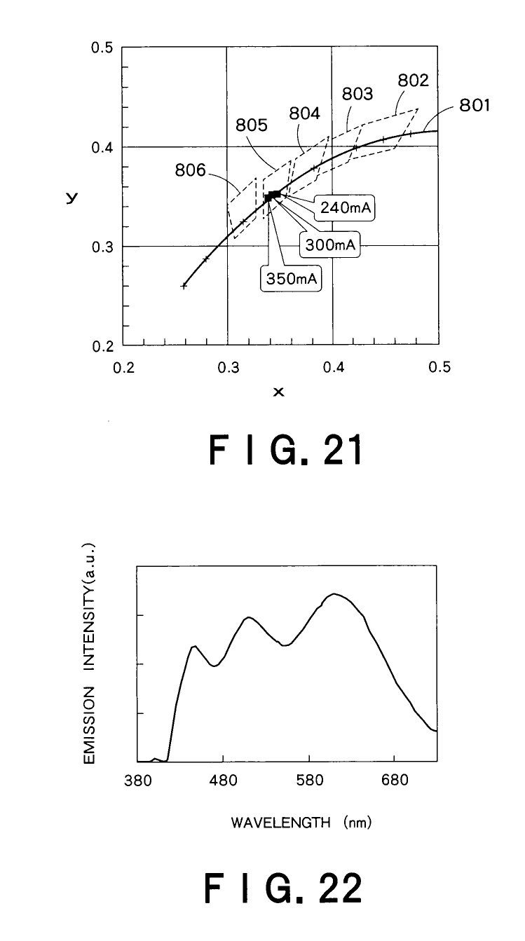

While the drive current was gradually increased up to 350 mA, the emission properties of the obtained device were measured in the above manner. The result was shown in FIG. 21. As shown in FIG. 21, the chromaticity varied to such a small extent that it did not deviate from the range of natural white regulated by JIS even when the drive current was 350 mA. The luminous efficacy, Ra value and chromaticity were 46.5 lm/W, Ra=91 and (x, y)=(0.34, 0.351), respectively, at the drive current of 240 mA; 43.5 lm/W, Ra=81 and (x, y)=(0.339, 0.35), respectively, at the drive current of 300 mA; and 39.9 lm/W, Ra=90 and (x, y)=(0.336, 0.348), respectively, at the drive current of 350 mA. These results indicate that the luminous efficacy, Ra value and chromaticity varied only slightly.

### Example 8

The procedure of Example 4 was repeated to synthesize the green fluorescent substance (G1). Thereafter, the procedure of Example 4 was further repeated except for changing only the firing atmosphere, to synthesize a red fluorescent substance (R4). A light-emitting diode giving an emission peak at 390 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R4) giving an emission peak at 615 nm. Further, another layer of transparent resin containing 30 wt. % of the green fluorescent substance (G1) was provided thereon. Furthermore, still another layer of transparent resin containing 30 wt. % of the blue fluorescent substance (B1) was provided thereon. Thus, a light-emitting device was produced.

The produced device was placed in an integrating sphere, and then worked under the conditions of 20 mA and 3.1 V. The emitted light was observed to have the chromaticity of (0.345, 0.352), the color temperature of 5000K, the luminous efficacy of 53.14 lm/W and Ra=94. The emission spectrum of the light-emitting device was shown in FIG. 22.

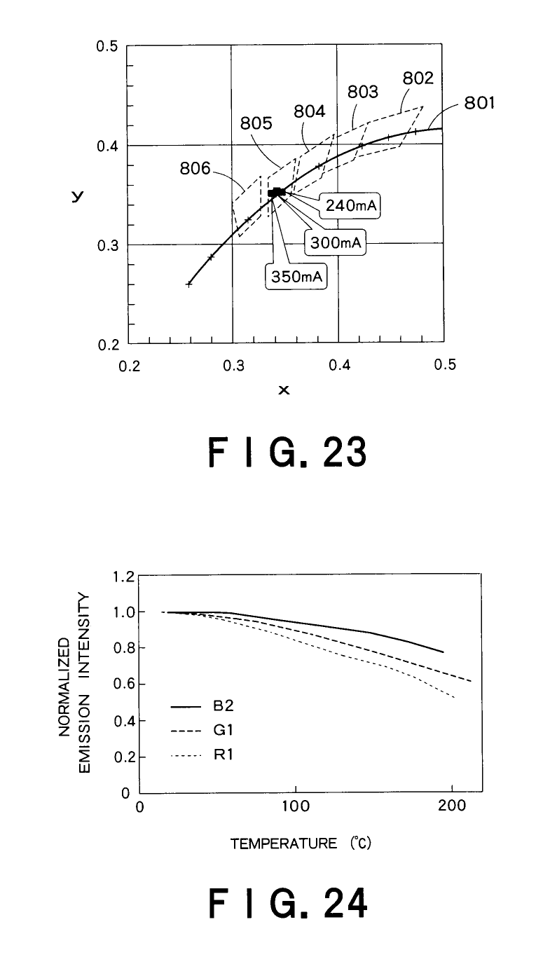

While the drive current was gradually increased up to 350 mA, the emission properties of the obtained device were measured in the above manner. The result was shown in FIG. 23. As shown in FIG. 23, the chromaticity varied to such a small extent that it did not deviate from the range of natural white regulated by JIS even when the drive current was 350 mA. The luminous efficacy, Ra value and chromaticity were 41.7 lm/W, Ra=94 and (x, y)=(0.339, 0.353), respectively, at the drive current of 240 mA; 39.1 lm/W, Ra=94 and (x, y)=(0.338, 0.352), respectively, at the drive current of 300 mA; and 36.2 lm/W, Ra=94 and (x, y)=(0.34, 0.351), respectively, at the drive current of 350 mA. These results indicate that the luminous efficacy, Ra value and chromaticity varied only slightly.

### Example 9

As the starting materials, SrCO₃, Eu₂O₃, Si₃N₄, and AlN in the amounts of 0.664 g, 0.792 g, 3.788 g and 7.009 g, respectively, were weighed and dry-mixed in an agate mortar. The mixture was placed in a BN crucible and then fired at 1800° C. for 4 hours under 7.5 atm of N₂ atmosphere, to synthesize a fluorescent substance (B2) whose designed composition was (Sr_{0.50}Eu_{0.50})₃Al₁₉Si₉ON₃₁.

The procedure of Example 1 was then repeated to synthesize the red and green fluorescent substances (R1) and (G1). A light-emitting diode giving an emission peak at 390 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R1) giving an emission peak at 598 nm. Further, another layer of transparent resin containing 30 wt. % of the green fluorescent substance (G1) was provided thereon. Furthermore, still another layer of transparent resin containing 30 wt. % of the blue fluorescent substance (B2) was provided thereon. Thus, a light-emitting device was produced. With respect to intensity of the emissions from the red, green and blue fluorescent substances, the temperature dependence thereof was shown in FIG. 24 provided that the intensity at room temperature was normalized at 1.

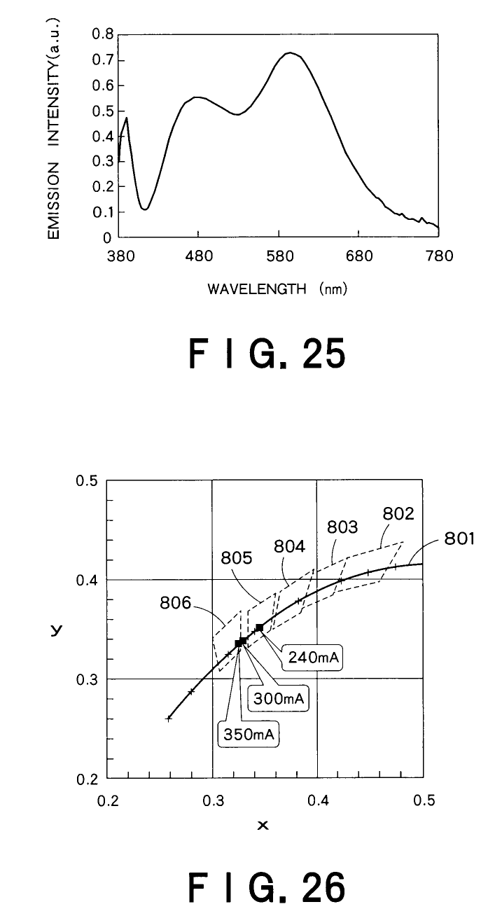

The produced device was placed in an integrating sphere, and then worked under the conditions of 20 mA and 3.1 V. The emitted light was observed to have the chromaticity of (0.345, 0.352), the color temperature of 5000K, the luminous efficacy of 56.09 lm/W and Ra=89. The emission spectrum of the light-emitting device was shown in FIG. 25.

While the drive current was gradually increased up to 350 mA, the emission properties of the obtained device were measured in the above manner. The result was shown in FIG. 26. As shown in FIG. 26, the chromaticity varied to such a small extent that it did not deviate from the range of natural white regulated by JIS even when the drive current was 350 mA. The luminous efficacy, Ra value and chromaticity were 43.9 lm/W, Ra=85 and (x, y)=(0.331, 0.340), respectively, at the drive current of 240 mA; 43.9 lm/W, Ra=85 and (x, y)=(0.329, 0.339), respectively, at the drive current of 300 mA; and 38.0 lm/W, Ra=84 and (x, y)=(0.327, 0.337), respectively, at the drive current of 350 mA. These results indicate that the luminous efficacy, Ra value and chromaticity varied only slightly.

### Comparative Example 1

The procedure of Example 1 was repeated to synthesize the green fluorescent substance (G1). Thereafter, as the starting materials, Sr₃N₂, EuN, Si₃N₄, Al₂O₃ and AlN in the amounts of 1.357 g, 2.324 g, 4.583 g, 0.476 g and 1.339 g, respectively, were weighed and dry-mixed in an agate mortar in a vacuum glove box. The mixture was placed in a BN crucible and then fired at 1850° C. for 4 hours under 7.5 atm of N₂ atmosphere, to synthesize a fluorescent substance (R9) whose designed composition was (Sr_{0.50}Eu_{0.50})₂Al₃Si₇ON₁₃.

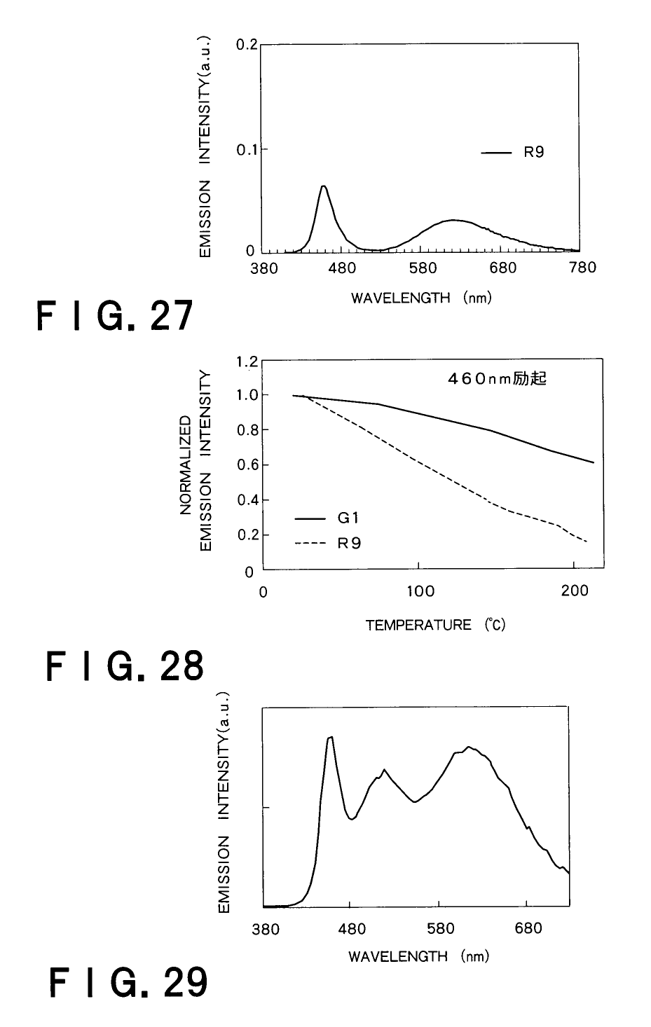

The fluorescent substance (R9) obtained by firing was in the form of orange powder, and was observed to emit red luminescence when excited by black light. The emission spectrum of the obtained red fluorescent substance under the excitation at 457 nm was shown in FIG. 27. Further, with respect to intensity of the emissions from the red and green fluorescent substances (R9) and (G1), the temperature dependence thereof was shown in FIG. 28 provided that the intensity at room temperature was normalized at 1. Furthermore, the red fluorescent substance (R9) was subjected to X-ray diffraction analysis by the use of a CuKa characteristic X-ray (wavelength: 1.54056 Å). As a result, the red fluorescent substance (R9) exhibited an XRD profile having peaks at 8.64°, 11.18° and 18.30°.

A light-emitting diode giving an emission peak at 455 nm was soldered on an 8 mm-square AlN package, and was connected to electrodes by way of gold wires. The light-emitting diode was then domed with transparent resin, and the dome was coated with a layer of transparent resin containing 30 wt. % of the red fluorescent substance (R9) giving an emission peak at 598 nm. Further, another layer of transparent resin containing 30 wt. % of the green fluorescent substance (G1) was provided thereon. Thus, a light-emitting device was produced.

The produced device was placed in an integrating sphere, and then worked under the conditions of 20 mA and 3.1 V. The emitted light was observed to have the chromaticity of (0.345, 0.352), the color temperature of 5000K, the luminous efficacy of 24.0 lm/W and Ra=91. The emission spectrum of the light-emitting device was shown in FIG. 29.

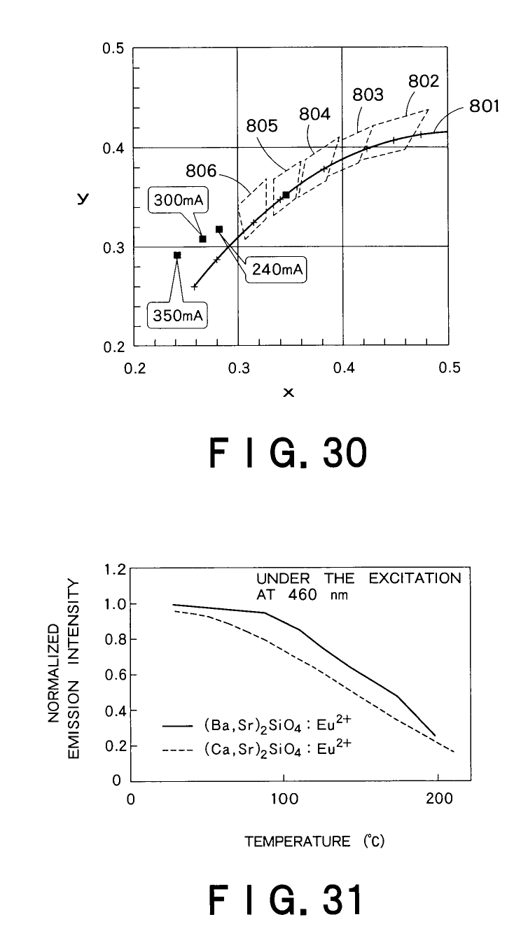

While the drive current was gradually increased up to 350 mA, the emission properties of the obtained device were measured in the above manner. The result was shown in FIG. 30. As shown in FIG. 30, the chromaticity varied to such a large extent that it deviated considerably from the range regulated by ES when the drive current was increased. The luminous efficacy and Ra value were 15.5 lm/W and Ra=72, respectively, at the drive current of 240 mA; 14.0 lm/W and Ra=66, respectively, at the drive current of 300 mA; and 12.2 lm/W and Ra=53, respectively, at the drive current of 350 mA.

These results indicate that the luminous efficacy and Ra value seriously degraded.

### Comparative Example 2

A light-emitting diode giving an emission peak at 455 nm was soldered on an 8 mm-square AlN package, and was connected to electrodes by way of gold wires. The light-emitting diode was then domed with transparent resin, and the dome was coated with a layer of transparent resin containing 40 wt. % of a red fluorescent substance (Ba_{0.1}Sr_{0.8}Ca_{0.1})₂SiO₄:Eu²⁺ giving an emission peak at 585 nm. Further, another layer of transparent resin containing 30 wt. % of a green fluorescent substance (Ba_{0.1}Sr_{0.9})₂SiO₄:Eu²⁺ was provided thereon. Thus, a light-emitting device shown in FIG. 6 was produced. With respect to intensity of the emissions from the red and green fluorescent substances, the temperature dependence thereof was shown in FIG. 31 provided that the intensity at room temperature was normalized at 1.

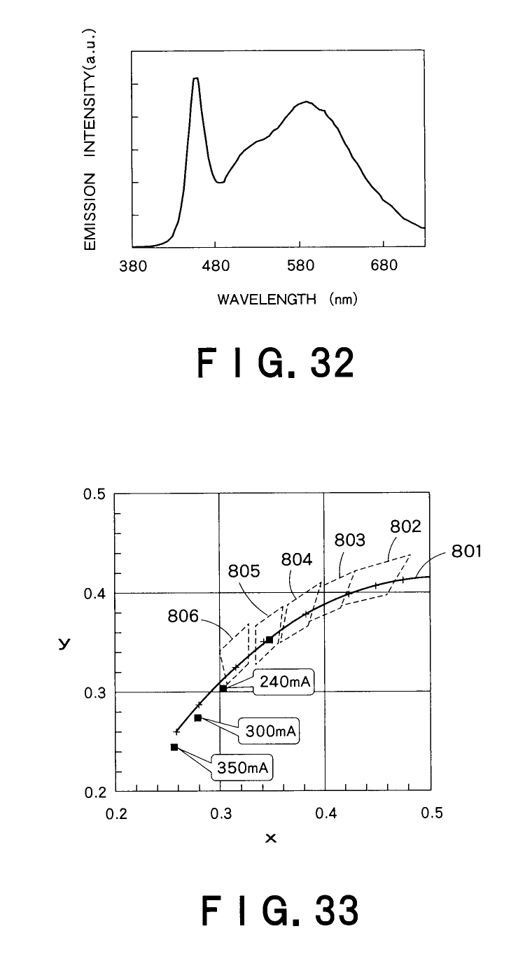

The produced device was placed in an integrating sphere, and then worked under the conditions of 20 mA and 3.1 V. The emitted light was observed to have the chromaticity of (0.345, 0.352), the color temperature of 5000K, the luminous efficacy of 68.6 lm/W and Ra=86. The emission spectrum of the light-emitting device working at the drive current of 20 mA was shown in FIG. 32.

While the drive current was gradually increased up to 350 mA, the emission properties of the obtained device were measured in the above manner. The result was shown in FIG. 33. As shown in FIG. 33, the chromaticity varied to such a large extent that it deviated considerably from the range regulated by ES when the drive current was increased. The luminous efficacy and Ra value were 43.9 lm/W and Ra=76, respectively, at the drive current of 240 mA; 33.9 lm/W and Ra=68, respectively, at the drive current of 300 mA; and 26.9 lm/W and Ra=57, respectively, at the drive current of 350 mA. These results indicate that the luminous efficacy and Ra value seriously degraded.

TABLE 3

| | Sub- | | | Sr + | | | | | |
|---|---|---|---|---|---|---|---|---|---|
| | stance | Sr | Eu | Eu | Al | Si | O | N | C |
| Ex. 1 | R1 | 0.65 | 0.04 | 0.69 | 1.00 | 2.32 | 0.46 | 4.20 | 0.00 |
| Ex. 2 | R2 | 0.68 | 0.01 | 0.69 | 1.00 | 2.37 | 0.50 | 4.30 | 0.01 |
| Ex. 3 | R3 | 0.62 | 0.07 | 0.69 | 1.00 | 2.32 | 0.46 | 4.30 | 0.01 |
| Ex. 4 | R4 | 0.57 | 0.10 | 0.69 | 1.00 | 2.27 | 0.43 | 4.30 | 0.01 |
| Ex. 5 | R1 | 0.63 | 0.03 | 0.66 | 1.00 | 2.28 | 0.45 | 4.20 | 0.00 |
| Ex. 6 | R2 | 0.66 | 0.01 | 0.67 | 1.00 | 2.32 | 0.50 | 4.20 | 0.01 |
| Ex. 7 | R3 | 0.59 | 0.07 | 0.66 | 1.00 | 2.28 | 0.45 | 4.20 | 0.00 |
| Ex. 8 | R4 | 0.56 | 0.10 | 0.66 | 1.00 | 2.26 | 0.41 | 4.20 | 0.01 |

1. A fluorescent substance comprising an inorganic compound which comprises:
a metal element M,
an element M¹ selected from the group of trivalent elements other than said metal element M,
an element M² selected from the group of tetravalent elements other than said metal element M, and
nitrogen element,
said metal element M being partly replaced with a luminescent center element EC;
wherein chemical bond lengths of M¹-N and M²-N calculated from a lattice constants and atomic coordinates in the crystal structure of said fluorescent substance are within the range of ±15% based on those of Al—N and Si—N, respectively, calculated from the lattice constants and atomic coordinates of Sr₂Al₃Si₇ON₁₃.

2. The substance according to claim 1, wherein the substance further comprises oxygen element.

3. The substance according to claim 1, wherein the substance has a composition represented by the formula (1):
(M₁₋ₓECₓ)ₐSi_{b}AlO_{c}N_{d} (1)
in which M is an element selected from the IA group elements, the IIA group elements, the IIIA group elements, the IIIB group elements, the rare earth elements and the IVA group elements; EC is an element selected from the group consisting of Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe; and x, a, b, c and d are numbers satisfying the conditions of 0<x<0.4, 0.65<a<0.70, 2<b<3, 0.3<c<0.6 and 4<d<5, respectively; and
the fluorescent substance emits luminescence having a peak in the wavelength range of 570 to 650 nm when excited with light in the wavelength range of 250 to 500 nm.

4. The substance according to claim 1, produced by the process in which a nitride or carbide of said metal element M, a nitride, oxide or carbide of said element M¹, a nitride, oxide or carbide of said element M², and an oxide, nitride or carbonate of said luminescent center element EC are mixed as starting materials and then fired.

5. A light-emitting device comprising
a light-emitting chip (S1) giving off light in the wavelength range of 250 to 500 nm;
a fluorescent substance (R) comprising an inorganic compound which comprises:
a metal element M,
an element M¹ selected from the group of trivalent elements other than said metal element M,
an element M² selected from the group of tetravalent elements other than said metal element M, and
nitrogen element,
said metal element M being partly replaced with a luminescent center element EC;
wherein chemical bond lengths of M¹-N and M²-N calculated from a lattice constants and atomic coordinates in the crystal structure of said fluorescent substance are within the range of ±15% based on those of Al—N and Si—N, respectively, calculated from the lattice constants and atomic coordinates of Sr₂Al₃Si₇ON₁₃; and
the substance emits luminescence having a peak in the wavelength range of 580 to 650 nm when excited with light given by said light-emitting chip (S1); and
a fluorescent substance (G) comprising an inorganic compound which comprises:
a metal element M′,
an element M′¹ selected from the group of trivalent elements other than said metal element M′,
an element M′² selected from the group of tetravalent elements other than said metal element M′, and
nitrogen element,
said metal element M′ being partly replaced with a luminescent center element EC′;
wherein chemical bond lengths of M′¹-N and M′²-N calculated from a lattice constants and atomic coordinates in the crystal structure of said fluorescent substance are within the range of ±15% based on those of Al—N and Si—N, respectively, calculated from the lattice constants and atomic coordinates of Sr₃Al₃Si₁₃O₂N₂₁; and
the fluorescent substance emits luminescence having a peak in the wavelength range of 490 to 580 nm when excited with light given by said light-emitting chip (S1).

6. The device according to claim 5, wherein at least one of the fluorescent substance (R) and the fluorescent substance (G) further comprises oxygen element.

7. The device according to claim 5, wherein said fluorescent substance (R) is represented by the formula (1):
(M₁₋ₓECₓ)ₐSi_{b}AlO_{c}N_{d} (1)
in which M is an element selected from the IA group elements, the IIA group elements, the IIIA group elements, the IIIB group elements, the rare earth elements and the IVA group elements; EC is an element selected from the group consisting of Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe; and x, a, b, c and d are numbers satisfying the conditions of 0<x<0.4, 0.65<a<0.70, 2<b<3, 0.3<c<0.6 and 4<d<5, respectively.

8. The device according to claim 5, wherein said fluorescent substance (G) is placed over said light-emitting chip and is represented by the formula (2):
(M′₁₋ₓEC′ₓ)_{3-y}Al_{3+z}Si_{13-z}O₂₊ᵤN_{21-w} (2)
in which M′ is an element selected from the IA group elements, the IIA group elements, the IIIA group elements, the IIIB group elements, the rare earth elements and the IVA group elements; EC′ is an element selected from the group consisting of Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe; and x, y, z, u and w are numbers satisfying the conditions of 0<x≦1, −0.1≦y≦0.15, −1≦z≦1 and −1<u−w≦1, respectively.

9. A light-emitting device comprising
a light-emitting chip (S2) giving off light in the wavelength range of 250 to 430 nm;
a fluorescent substance (R) comprising an inorganic compound which comprises:
a metal element M,
an element M¹ selected from the group of trivalent elements other than said metal element M,
an element M² selected from the group of tetravalent elements other than said metal element M, and
nitrogen element,
said metal element M being partly replaced with a luminescent center element EC;
wherein chemical bond lengths of M¹-N and M²-N calculated from a lattice constants and atomic coordinates in a crystal structure of said fluorescent substance are within the range of ±15% based on those of Al—N and Si—N, respectively, calculated from the lattice constants and atomic coordinates of Sr₂Al₃Si₇ON₁₃; and
the fluorescent substance (R) emits luminescence having a peak in the wavelength range of 580 to 650 nm when excited with light given by said light-emitting chip (S2);
a fluorescent substance (G) comprising an inorganic compound which comprises:
a metal element M′,
an element M′¹ selected from the group of trivalent elements other than said metal element M′,
an element M′² selected from the group of tetravalent elements other than said metal element M′, and
nitrogen element,
said metal element M′ being partly replaced with a luminescent center element EC′;
wherein chemical bond lengths of M′¹-N and M′²-N calculated from a lattice constants and atomic coordinates in the crystal structure of said fluorescent substance are within the range of ±15% based on those of Al—N and Si—N, respectively, calculated from the lattice constants and atomic coordinates of Sr₃Al₃Si₁₃O₂N₂₁; and
the fluorescent substance (G) emits luminescence having a peak in the wavelength range of 490 to 580 nm when excited with light given by said light-emitting chip (S2); and
a fluorescent substance (B) which emits luminescence having a peak in the wavelength range of 400 to 490 nm when excited with light given by said light-emitting chip (S2).

10. The device according to claim 9, wherein at least one of the fluorescent substance (R) and the fluorescent substance (G) further comprises oxygen element.

11. The device according to claim 9, wherein said fluorescent substance (R) is represented by the formula (1):
(M₁₋ₓECₓ)ₐSi_{b}AlO_{c}N_{d} (1)
in which M is an element selected from the IA group elements, the IIA group elements, the IIIA group elements, the IIIB group elements, the rare earth elements and the IVA group elements; EC is an element selected from the group consisting of Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe; and x, a, b, c and d are numbers satisfying the conditions of 0<x<0.4, 0.65<a<0.70, 2<b<3, 0.3<c<0.6 and 4<d<5, respectively.

12. The device according to claim 9, wherein said fluorescent substance (G) is placed over said light-emitting chip and is represented by the formula (2):
(M′₁₋ₓEC′ₓ)_{3-y}Al_{3+z}Si_{13-z}O₂₊ᵤN_{21-w} (2)
in which M′ is an element selected from the IA group elements, the IIA group elements, the IIIA group elements, the IIIB group elements, the rare earth elements and the IVA group elements; EC′ is an element selected from the group consisting of Eu, Ce, Mn, Tb, Yb, Dy, Sm, Tm, Pr, Nd, Pm, Ho, Er, Cr, Sn, Cu, Zn, As, Ag, Cd, Sb, Au, Hg, TI, Pb, Bi and Fe; and x, y, z, u and w are numbers satisfying the conditions of 0<x≦1, −0.1≦y≦0.15, −1z≦1 and −1<u−w≦1, respectively.
